(19) United States
(12) Patent Application Publication
(10) Pub. No.: US 2015/0347567 A1
(43) Pub. Date: Dec. 3, 2015

(54) METHOD FOR CREATION AND EDITING OF A MASSIVE CONSTRAINT NETWORK

(71) Applicant: Siemens Product Lifecycle Management Software Inc., Plano, TX (US)

(72) Inventors: Matthew Stevenson, Suffolk (GB); Dick Baardse, Geldermalsen (NL); Austin Benson, Cambridge (GB); Eric Leeson, Mason, OH (US); Satyanarayana Guduru, Mason, OH (US); Thomas Tabeling, Cincinnati, OH (US)

(73) Assignee: Siemens Product Lifecycle Management Software Inc., Plano, TX (US)

(21) Appl. No.: 14/289,380

(22) Filed: May 28, 2014

(51) Int. Cl. G06F 17/30; H04L 29/06; G06F 3/0484

(52) U.S. Cl. CPC G06F 17/30601; G06F 3/0484; G06F 17/30864; H04L 65/403

(57) ABSTRACT

A method for editing a position of a selected design element in a constraint network. The method includes receiving a selection of a design element in a geometric model from a user. The method also includes searching a database for a positioning group related to the selected design element. The method then includes displaying the positioning group related to the selected design element to the user. The method further includes receiving an updated positioning group from the user. The method finally includes storing the updated positioning group to the database.

### CROSS-REFERENCE TO OTHER APPLICATION

This application shares some subject matter with commonly-assigned, concurrently filed U.S. patent application Ser. No. ______ for “Intelligent Constraint Selection for Positioning Tasks” (Attorney Docket 2014P09179US), which is hereby incorporated by reference.

### TECHNICAL FIELD

The present disclosure is directed, in general, to computer-aided design (“CAD”), visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include methods for editing a position of a selected design element in a constraint network. The method includes receiving a selection of a design element in a geometric model from a user. The method also includes searching a database for a positioning group related to the selected design element. The method then includes displaying the positioning group related to the selected design element to the user. The method further includes receiving an updated positioning group from the user. The method finally includes storing the updated positioning group to the database.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 illustrates a relationship between two design elements in accordance with the present disclosure;

FIG. 3 illustrates position groups in a constraint network in accordance with the present disclosure;

FIG. 4 illustrates a method for dividing a constraint network in accordance with the present disclosure; and

FIG. 5 illustrates a method for editing a constraint network in accordance with the present disclosure.

### DETAILED DESCRIPTION

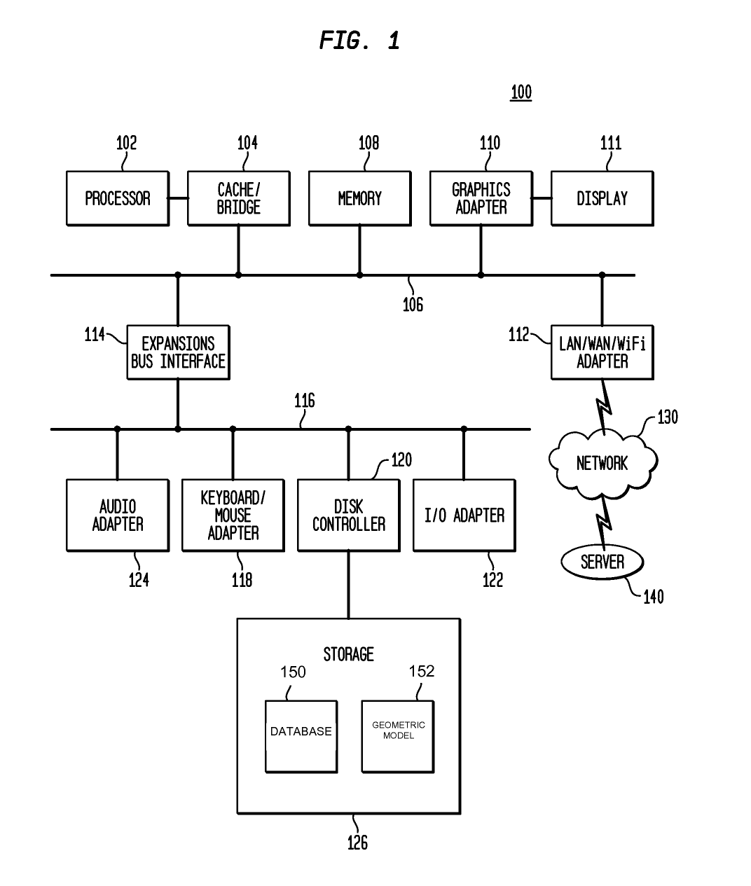

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Millions of parts could be constrained in a single constraint network in a product, increasing the amount of memory required to load the model and restricting suitable hardware. To increase work productivity and efficiency, the system automatically breaks up the constraint network into smaller pieces without interaction from the user. The smaller pieces allow users to only download the design element or elements that the user is currently editing which requires less memory. Having the user only download the positioning constraints needed for specific design elements also allows multiple users to edit a single assembly or subassembly without locking each other out or overwriting each other's work.

FIG. 1 depicts a block diagram of a data processing system in which an embodiment can be implemented, for example, as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. The storage 126 stores the database 150 and the geometric model 152, and so on, which are described below.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments provide systems and methods that manage constraints between design elements in a PDM system. In particular, disclosed techniques can apply rules to manage interactions between rigid constraints and other constraints.

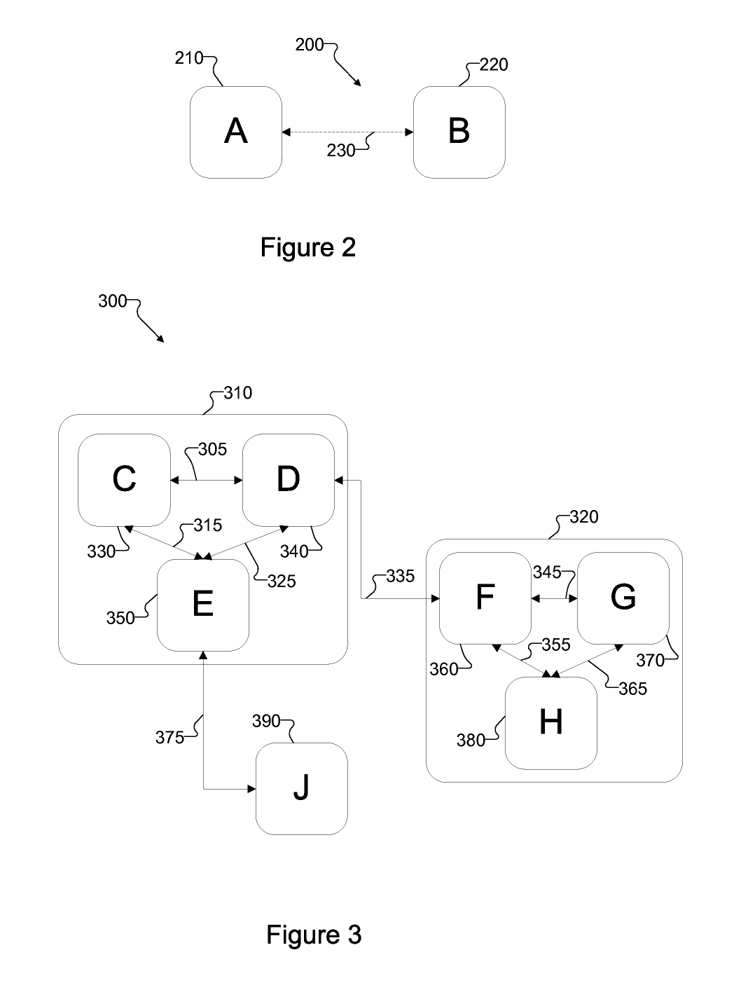

FIG. 2 illustrates a relationship between two design elements in accordance with the present disclosure. Sets of positioning constraints 230 are relationships between two design elements 200. The design elements, which can be implemented as or function the same as occurrences in an assembly structure, can also be any type of object including parts, subassemblies, assemblies, and sketches. The positioning constraints can be any functional relationship between two design elements including mating geometries, aligning geometries, parallel geometries, perpendicular geometries, coincident geometries, concentric geometries, tangent geometries, distance between geometries, angle between geometries, or any other positioning constraint. The sets of positioning constraints 230 shows only one line in the figures, but may represent one constraint or multiple constraints between the two design elements which the line connects.

In FIG. 2, the set of positioning constraint 230 represents a relationship between design element A 210 and design element B 220. The relationship is bidirectional. From the viewpoint of design element A 210, the set of positioning constraint 230 could indicate that the right side of design element A 210 touches the left side of design element B 220. Alternatively from the viewpoint of design element B 220, the set of positioning constraint 230 could indicate that the left side of design element B 200 touches the right side of design element A 210.

FIG. 3 illustrates position groups in a constraint network in accordance with the present disclosure. A constraint network contains a plurality of positioning constraints concerning a plurality of design elements. The depicted constraint network 300 contains seven design elements (design element C 330, design element D 340, design element E 350, design element F 360, design element G 370, design element H 380, and design element J 390) and eight sets of positioning constraints 230 (positioning constraints 305, positioning constraints 315, positioning constraints 325, and positioning constraints 335, positioning constraints 345, positioning constraints 355, positioning constraints 365, and positioning constraints 375), but a constraint network may contain any number of design elements and sets of positioning constraints 230. While the highest amount of positioning constraints on a design element shown in FIG. 3 is three sets of constraints, a design element may contain any amount of set of positioning constraints 230. Every design element contains at least one set of positioning constraints 230.

A positioning group, also referred to herein as a geometric constraint collection, is composed of a group of design elements, also known as foreground design elements, and the sets of positioning constraints 230 that define the positions of the design elements in the positioning group. The positioning group also contains references to the design elements, also known as background design elements, that are outside the positioning group but are needed for the sets of positioning constraints 230 contained within the positioning group. In one embodiment, a design element or a constraint is in the foreground of only one positioning group. In another embodiment, design elements and positioning constraints may be contained in multiple positioning groups. In certain embodiments, some design elements may not be included in any positioning group.

Suitable methods of dividing the constraint network into positioning groups include dividing by minimal number of positioning groups, by smallest positioning groups, ownership of the positioning groups, or by dependencies of the design element.

FIG. 3 illustrates an example of two positioning groups, positioning group 310 and positioning group 320, from constraint network 300. The positioning group 310 is created for the positioning of design element C 330, design element D 340, and design element E 350. The positioning constraints 305, positioning constraints 315, positioning constraints 325, positioning constraints 335, and positioning constraints 375 are all used to position the design elements contained in positioning group 310 and are also included in positioning group 310. When positioning group 310 is selected, the positioning constraints references to the background design elements including design element F 360 and design element E 390 and these design elements are included as background design elements in positioning group 310.

The positioning group 320 is created for the positioning of design element F 360, design element G 370, and design element H 380. The positioning constraints 335, positioning constraints 345, positioning constraints 355, and positioning constraints 365 are all used to position the design elements contained in positioning group 310 and are also included in positioning group 310. When positioning group 320 is selected, the positioning constraints references design element D 340 and is included as a background design element in positioning group 320.

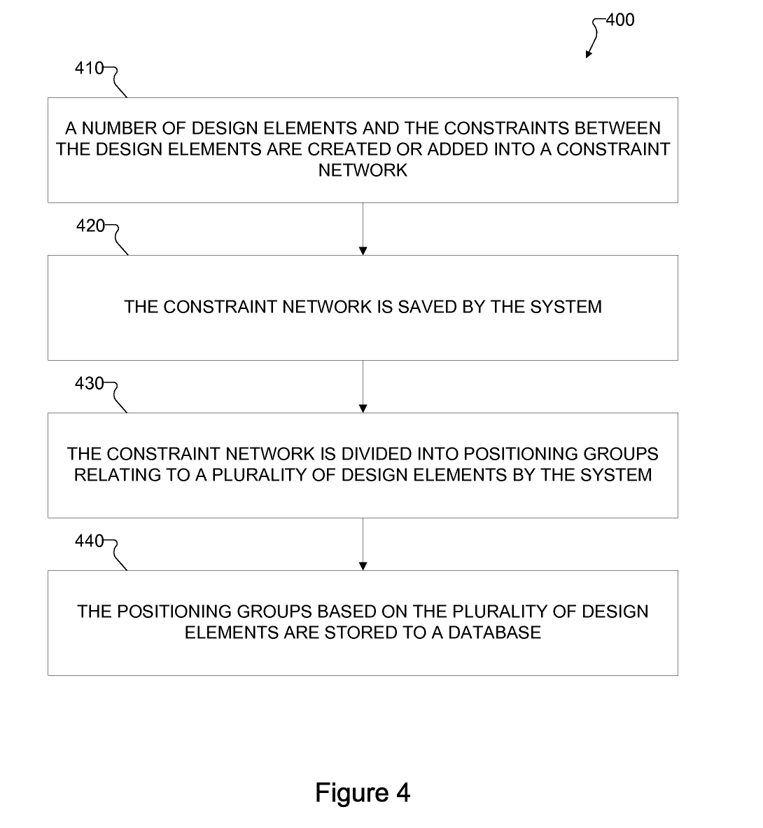

FIG. 4 illustrates a method for dividing a constraint network 400.

In step 410, the system receives a constraint network a number of design elements and the constraints between the design elements are created or added into a constraint network from a user.

In step 420, the constraint network is saved by the system. Once the user saves the constraint network, the process to divide the constraint network into positioning groups starts.

In another embodiment, the constraint network is loaded to the system for the purpose of dividing the constraint network into positioning groups.

In step 430, the constraint network is automatically divided into positioning groups relating to a plurality of design elements by the system. Constraint networks are divided into different positioning groups to more efficiently access and edit individual design elements of the constraint network. The positioning groups allow the constraint network to be accessed by multiple users when the design elements are not being accessed or referenced by another user. The automatically defined positioning group will typically contain references to the constraints of a single design element and will be invisible to the user.

In an alternative embodiment, the user can define sets of design elements. The constraints between these design elements are all in a single positioning group, which is referred to as a user defined group. These groups and their design elements behave like sub constraint networks.

In step 440, the positioning groups based on the plurality of design elements are stored to a database 150.

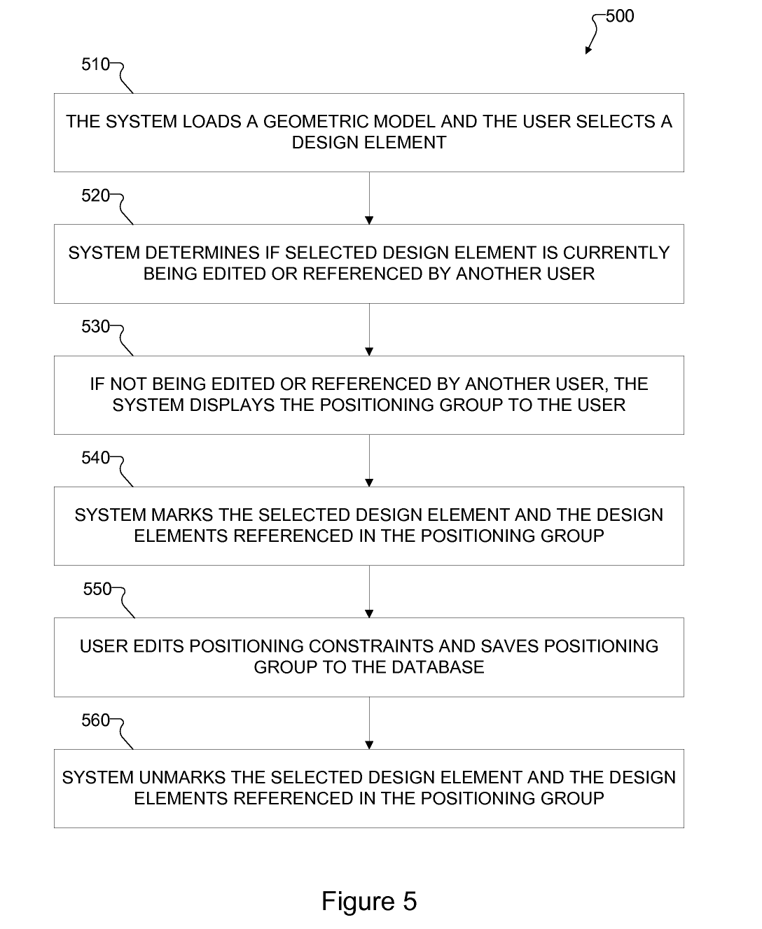

FIG. 5 illustrates a method for editing a constraint network 500.

In step 510, the system loads a geometric model 152. The user then selects a design element and the system receives the user selection of the design element.

In certain embodiments, the system determines if the user has write access to the selected design element or other design element in the positioning group. If the user does not have write access to a design element in the positioning group, the system can lock the constraints for that single design element or lock the user from changing any constraints in the positioning group.

In one embodiment, the system then searches the database (150) for positioning groups that reference the selected design element. The positioning groups may also reference design elements other than the selected design element. The data management system provides mechanisms to navigate the constraint network in a configured way in either a precise or imprecise fashion. Navigation in a precise fashion means that the specific revisions of occurrences referenced by the as-saved state will be returned. Navigation in an imprecise fashion means that the application or user supplied configuration criteria will be applied to all sibling revisions of the occurrences referenced by the as-saved state. The revisions which configures will be returned. Foreground occurrences get an additional level of filtering applied to eliminate sibling revisions which do not reference any as-saved state of the positioning group, meaning their positions are not impacted by (and therefore not members of) the positioning group. The data management system supports traversal of positioning groups as part of its occurrence search process.

In certain embodiments, the system attempts to determine the best possible as-saved state to use when loading constraints into CAD. The best possible as-saved is determined by finding the latest as-saved state of the positioning group which last impacted one of the configured members of the group. To find the configured members of a geometric constraint collection, the data management system must first search across all foreground members referenced by each as-saved state of the geometric constraint collection. The system then finds the sibling revisions of each possible member which configures. The system will automatically eliminate sibling revisions which are not impacted by the geometric constraint collection. The occurrence revisions are considered non-impacted when they have no reference to any as-saved state of the geometric constraint collection. Next, the system selects the latest as-saved state of the geometric constraint collection referenced by any of the configured occurrences of the sibling revisions found.

In step 520, the system determines if the selected design element is currently selected or referenced by another user. To determine if the selected design element is currently selected the system checks the database (150) to see if the selected design element is currently marked as selected or referenced in the positioning group selected by another user.

In another embodiment, when the positioning group contains other design elements than only the selected design element, the system also determines if the other design elements are marked as selected or referenced in the positioning group selected by another user.

In step 530, if the system determines that the selected design element or other design elements are not currently marked selected or referenced by another user, the system allows the user to load the positioning group and displays the positioning group related to the selected design element to the user. The system loads just enough information to edit the selected design element, not requiring a download of a full constraint network.

In step 540, the system marks the selected design element, the other design elements, and the design elements being referenced in the positioning group as selected by the user in the database (150).

In step 550, the user edits the positioning constraints and saves the updated positioning group to the database (150). The system receives the updated positioning group from the user and stores the update positioning group to the database (150).

In step 560, the system unmarks the selected design element, the other design elements, and the design elements being referenced in the positioning group in the database (150).

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for editing a position of a selected design element in a constraint network comprising:
receiving a selection of a design element in a geometric model from a user;
searching a database for a positioning group related to the selected design element;
displaying the positioning group related to the selected design element to the user;
receiving an updated positioning group from the user; and
storing the updated positioning group to the database.

2. The method for editing a position of a selected design element of claim 1, further comprising:
receiving the constraint network from the user;
dividing the constraint network into a plurality of positioning groups; and
storing the plurality of positioning groups to the database.

3. The method for editing a position of a selected design element of claim 2, wherein the constraint network comprises a plurality of positioning constraints concerning a plurality of design elements.

4. The method for editing a position of a selected design element of claim 2, wherein dividing the constraint network into the plurality of positioning groups comprises dividing the constraint network by ownership of the positioning groups, minimal number of positioning groups, or smallest positioning groups.

5. The method for editing a position of a selected design element of claim 1, wherein the positioning group contains the selected design element, a plurality of positioning constraints related to the selected design element, and references to a plurality of design elements that are referenced by the plurality of positioning constraints.

6. The method for editing a position of a selected design element of claim 1, wherein searching the database for the positioning group comprises determining if the selected design element is marked selected or referenced by another user.

7. The method for editing a position of a selected design element of claim 1, further comprising:
marking the selected design elements and referenced design elements as selected or referenced by the user until the updated positioning group is stored to the database.

8. A data processing system comprising:
a processor; and
an accessible memory, the data processing system particularly configured to receive a selection of a design element in a geometric model from a user;
search a database for a positioning group related to the selected design element;
display the positioning group related to the selected design element to the user;
receive an updated positioning group from the user; and
store the updated positioning group to the database.

9. The data processing system of claim 8, wherein the data processing system is further configured to:
receive the constraint network from a user;
divide the constraint network into a plurality of positioning groups; and
store the plurality of positioning groups to the database.

10. The data processing system of claim 9, wherein the constraint network comprises a plurality of positioning constraints concerning a plurality of design elements.

11. The data processing system of claim 9, wherein divide the constraint network into the plurality of positioning groups comprises dividing the constraint network by ownership of the positioning groups, minimal number of positioning groups, or smallest positioning groups.

12. The data processing system of claim 8, wherein the positioning group contains the selected design element, a plurality of positioning constraints related to the selected design element, and references to a plurality of design elements that are referenced by the plurality of positioning constraints.

13. The data processing system of claim 8, wherein searching the database for the positioning group comprises determining if the selected design element is marked selected or referenced by another user.

14. The data processing system of claim 8, further comprising:
mark the selected design elements and referenced design elements as selected or referenced by the user until the updated positioning group is stored to the database.

15. A non-transitory computer-readable medium encoded with executable instructions that, when executed, cause one or more data processing systems to:
receive a selection of a design element in a geometric model from a user;
search a database for a positioning group related to the selected design element;
display the positioning group related to the selected design element to the user;
receive an updated positioning group from the user; and
store the updated positioning group to the database.

16. The non-transitory computer-readable medium of claim 15, further comprising:
receive the constraint network from a user;
divide the constraint network into a plurality of positioning groups; and
store the plurality of positioning groups to the database.

17. The non-transitory computer-readable medium of claim 16, wherein the constraint network comprises a plurality of positioning constraints concerning a plurality of design elements.

18. The non-transitory computer-readable medium of claim 16, wherein divide the constraint network into the plurality of positioning groups comprises dividing the constraint network by ownership of the positioning groups, minimal number of positioning groups, or smallest positioning groups.

19. The non-transitory computer-readable medium of claim 15, wherein the positioning group contains the selected design element, a plurality of positioning constraints related to the selected design element, and references to a plurality of design elements that are referenced by the plurality of positioning constraints.

20. The non-transitory computer-readable medium of claim 15, wherein searching the database for the positioning group comprises determining if the selected design element is marked selected or referenced by another user.
